(19) United States
(12) Patent Application Publication
(10) Pub. No.: US 2002/0143873 A1
(43) Pub. Date: Oct. 3, 2002

(54) Method and apparatus for learning content creation and reutilization

(76) Inventor: David Lamp, Sterling, VA (US)

Correspondence Address: Hoffman, Wasson & Gitler, P.C., Suite 522, 2361 Jefferson Davis Highway, Arlington, VA, 22202, US

(21) Appl. No.: 09/821,011

(22) Filed: Mar. 30, 2001

Related U.S. Application Data
(60) Provisional application No. 60/240,081, filed on Oct. 16, 2000.

(51) Int. Cl. G06F 15/16; G09B 7/00

(52) U.S. Cl. 709/204; 434/323

(57) ABSTRACT

The present invention relates to a method and apparatus for learning content creation and reutilization with customizable learning object subsets. It is usable in a basic Internet browsing paradigm to successfully gather and distribute intellectual material and products. The present invention determines the appropriate placement and meaning of intellectual content as a component of a paradigm-based learning matrix. The content is sorted into a cluster from a structured collection of four learning objects. These clusters are then stored and retrieved dynamically, based on content expert determination or user need. The method and system can build a personalized learning preference by noting a pattern creativity of the same user employing the system over a period of time.

### BACKGROUND OF THE INVENTION

1. Field of the Invention

This invention relates to a method and apparatus for gathering and distributing content for use in a reusable learning object design and delivery system. In particular, this invention is directed to categorizing traditional learning content into a reusable learning object system. It creates a digital grammar for the learning technology market sector by establishing specifications and relationships between learning delivery objects used in the education and training process.

2. Description of Related Art

This invention is the logical extension of work that has been on-going in the instructional technology field as practitioners have sought to adequately utilize the Internet for learning. However, most of the work to date has sought merely to transfer the experience of the classroom to the virtual learning space. This invention provides a transformation process that determines the elements occurring in the learning process between teacher and student. For several hundred years, tools such as the blackboard, note taking and testing have been used with excellent results. However, it would be unfair to assume that there is some intrinsic educational power in the tools themselves. They merely provide an avenue for change; the event occurs within the minds of the participants.

This invention provides a methodology for breaking down the elements of the learning exchange into objects, which can then be gathered and delivered in various collections, based on the needs of the learner or the desires of the learning facilitator. This allows for an organized development process while at the same time allowing for the unique transmission requirements of the learning developer. Variant cultural examples or specific competencies can also be inserted into the learning stream as well as the revision or updating of facts and policy regulations or modification of values or vision focus without having to rebuild the entire learning event.

While many current educational web sites offer customization, none provide personalized learning at the depth this invention provides, since prior to this invention, all learning materials required rebuilding. This was the case for class handouts, books or static web pages. This invention provides for a level of granularity that limits the amount of rebuilding required, due to the fact that the initial created work has already been crafted with reuse in mind. But in order to understand the purpose of this invention, a review of the learning process is required.

Learning has traditionally been assumed to occur within a linear period of space/time. Classes were built for a particular learning period with a standard design of introduction, main points, application and review. Depending on the level of practical necessity, a laboratory or practicum period was added or inserted to give teachers an opportunity to illustrate competencies needed.

This invention is related to other projects that have influenced this invention. The first stage of this invention came from an initiative from the National Partnership for Reinventing Government. The project called for crafting a national virtual workplace. A training space was envisioned for this virtual workplace; a grant from the Department of Agriculture provided the funds to create such a virtual classroom. Called the Rural Internet Training Environment, this template-based system created 13 courses using cgi scripts that gave content creators an authoring template to work within. The problems that came from this initial development were the fact that no limitations or directions were given and huge text files and massive multimedia examples were created. This severely limited the ability to distribute these learning experiences over any but the most robust Internet connections.

The next level in developing a reusable learning object technology was the learning tool built by the Graduate School, USDA called AmeriSchool. This working prototype began the process of creating a framework of learning objects or components known as learning quartets. These learning objects were stored in a relational database and dynamically served to the browser. While having the potential to develop true reusability, AmeriSchool fell short of this invention by only using the basic templating of examples and exercises rather than building a personalized learning preference design and delivery system. By only breaking content into the pieces without awareness of the connections between content and learning, this tool was unable to be successfully fielded due to its high cost and slow implementation.

The Clinton Administration issued E.O. 13111 designed to encourage business and government to work together toward a shared standard for reusable learning. Unfortunately, this has meant largely that the participants have found ways to collaborate without having to agree on learning purpose. The SCORM, the Shareable Courseware Object Reference Model is the current state-of-the-art at the time of this application. It provides a mechanism to tag the learning object entities but does not truly transform the learning experience into an intuitive one. Rather it begins to create a bewildering array of descriptors that are without end.

### SUMMARY OF THE INVENTION

The present invention provides a method and system for gathering and distributing content for use in a reusable learning object design and delivery system.

This invention also provides a method for utilizing the content learning object collection in a customized user-directed learning environment to effectively deliver constantly improving content objects to two user groups, the educator user and the student user.

The first user group is the educator or subject matter expert. This content author is presented with a series of nesting and branching content containers whereby the information is sorted and stored by learning style and cognitive preference of the student user. This content gathering process is designed to facilitate the downloading of intellectual assets into a common structure where others can further refine or reuse them. It is anticipated that most content authors or educators will not create the content in Internet-ready manner. Therefore, they will be assisted with an authoring guidance system. This system's purpose is to gather expertise, procedure, strategy and illustration into useful instructional collections. Once gathered, the information can then be manipulated easily for improved interaction, awareness or accreditation. Multimedia designer/developers will be subset users of this first group. They will use the information stored in the system to create the multimedia or other illustrative materials in the learning system. Once the content has been created and stored, other educators, multimedia developers or subject matter experts can access the information re-utilize the content in different delivery styles or levels of learning.

The second user group is the student user. This knowledge seeker is presented with an interface that assists with the self-selection process of determining information type and learning preference. The activity of the user is monitored by the system in order to assist the educator with feedback as to the effectiveness of the content being utilized. The learning loop is designed to be constant and iterative wherein content becomes more effectively delivered and efficiently used.

The pedagogical construction for this learning design and delivery system is an eclectic one: the principle of constructionist theory combines with the more classical instructional one. FIG. 2 illustrates the process of the learning method used by the present invention. What one does first alone (as shown by Step 1 with the learner proceeding from point 10 to point 12) is then facilitated by a trusted agent or mentor (as shown by Step 2 proceeding from point 12 and point 14) who then directs the learner into a community of practice which then impacts the effect of the learning back to the learner (as shown by Step 3 proceeding from point 14 back to point 10).

In order for content to be distributed in a truly interactive way, the information within the distribution media must be sorted and stored in a standardized method. The granular distinctiveness of the storage engine used by the present invention takes as its hypothesis that all content is a matrix of interlocking collections of four memes or thought processes. The component nature of the system can be seen as the method of the collection process. The knowledge collection and distribution process is an exchange between sender and receiver in a dynamic interplay. The forces that make the process work are not the traditionally understood linear equation of space/time: learning a particular stream of thought or taking a particular sequence of skill colloquia. They are rather a dynamic one in which the four learning objects or eMemes as shown in FIG. 3 interact with one another as illustrated in FIG. 4 to form a cluster of information or Praxon. eMeme Alpha(α) is a rule in which a particular cognition is held to answer a specific fact or assist a question which can be assisted in the answered by observation. The eMeme gamma (γ) is a process in which particular action is felt and would be directed to a value judgment. The eMeme theta (θ) is the theory on which a particular cognition is held and would include a vision or parable. The eMeme delta (δ) is the process on which a particular action is taken, such as a step for a particular skill. The answers to these questions would create a form for the cluster of information Praxon shown in FIG. 4 and would be used to collect the content information of the Praxon in a manner which the eMeme of a particular Praxon can be catalogued in a database in a manner to aid in the learning process. As illustrated in FIG. 4, knowledge of this Praxon is facilitated by a fluid movement between the four eMemes.

The apparatus that makes this collection system work must be one that makes sense to the intuitive seeker for content collaboration. Previously, the only way to do this work was to learn something artificial and alien to the process by forcing information into the confines of a particular media or instructional design paradigm. The engine of the present invention uses rather the interactive ways of describing knowledge that the four communities who have gathered it naturally use. These communities which make up the content collections could be seen in their role of inspectors, mentors, storytellers and coaches, as shown in FIG. 4. The four nesting containers shown in FIG. 4 provide a place for each type of content to be sorted for further use and sophistication. The content creator begins in one of four informational systems: system, vision, protection and nurture. The content expert is asked for the purpose of the learning object of an eMeme: is it to describe a fact, a metaphorical illustration, a particular step for a skill, or a value judgment. For every one of these eMemes there are three other component parts making a reusable learning cluster or Praxon. The content creator does not have to have all the components when using the learning engine; it just provides a mechanism for the complete “learning process”. Each of these Praxon sets has the ability to connect to other systems for enhancing the experience—learning management, electronic commerce, rich media delivery and facilitative learning support.

Once the content has been gathered, enhanced and stored, it is ready for distribution to interested content users. A personal assistant for learning, or PAL, is used for this purpose. This interface provides the learner with a personalized portal to information based on professional skill set, job responsibility or management requirement. Since each of the four communities of FIG. 4 have different needs for excellence, the system can connect to any that are needed. The inspector or leadership role can allow for searching the entire body of knowledge, the skill or coach role can allow for competence certification by professional expert, the value or visionary role can review the progress made in the learning journey while the nurture or mentoring role can provide for encouragement and review of other's progress.

FIG. 4 explains the interactions between the forces at work in the mind of the learner. This chart shows how the essential component of learning—the eMeme—works collaboratively to accomplish a learning state. Two of the components, fact and theory, are static or “points” while the other two, skill and purpose, are dynamic or “processes” affecting the awareness of the static continuum. Since this is provided by dynamic distribution from the data warehouse, the PAL interface can be customized for the needs of those using it. This interface is the connection between content and creation so that over time the learner becomes a contributor to the knowledge repository. The preferences for learning can be gathered to further refine the way that the learning content is gathered and served. The security of the learner is paramount and whatever system is used to record the interactions must be left to the learner to disclose. This is the only mechanism that can insure the true vulnerability of the learner to the content; anything else provides the impression and manner of at best a proctor and at worst a manipulator.

### BRIEF DESCRIPTION OF THE DRAWINGS

The foregoing and other advantages and features of the invention will become more apparent from the detailed description of the preferred embodiments of the invention given below with reference to the accompanying drawings in which:

FIG. 1 is an overall diagram of the gathering sequence of learning object creation both as they are sorted into the database as eMemes and then as they are delivered as Praxons;

FIG. 2 is an illustration of the learning object process through the cognitive learning experience;

FIG. 3 is the dynamic model of the quantum state of learning forces interacting as they are gathered for use;

FIG. 4 is the interacting matrices of the learning object eMeme schema with traditional learning paradigms and outcomes superimposed for clarity;

FIG. 5 is a process flowchart illustrating the sequence of events for Praxon creation to the level of its first eMeme cluster;

FIG. 6 is a process flowchart illustrating the sequence of events for eMeme collection for the creation of an individual Praxon;

FIG. 7 is a process flowchart illustrating the sequence of events for Praxon utilization within other learning and economic processes;

FIG. 8 is a process flowchart illustrating the sequence of events for Praxon support and revision through the utilization of learning and customer relationship subsystems;

FIG. 9 is a process flowchart illustrating the sequence of events for the personal assistant for learning or PAL;

FIG. 10 is a naming convention matrix delineating the traditional terms used in learning content creation with their reusable learning object counterparts;

FIG. 11 is a design matrix schema delineating the traditional processes for the family of learning known in this invention as Alpha or topic starting the sequence. This factual approach to learning also has the ingredients of the other three but approaches them from a knowledge point of view;

FIG. 12 is a design matrix schema delineating the traditional processes for the family of learning known in this invention as Theta or strategy often ending the sequence. This visionary approach to learning has also the ingredients of the other three but approaches them from a conceptual point of view;

FIG. 13 is a design matrix schema delineating the traditional processes for the family of leaning known in this invention as Delta or exercise illustrating the practical aspects of the sequence. This skills-based approach to learning also has the ingredients of the other three but approaches them from a competency point of view; and

FIG. 14 is a design matrix schema delineating the traditional processes for the family of learning known in this invention as Gamma or example illustrating the community or team-building aspects of the sequence. This mentored approach to learning also has the ingredients of the other three but approaches them from a collaborative, purposeful point of view.

### DETAILED DESCRIPTION OF PREFERRED EMBODIMENTS

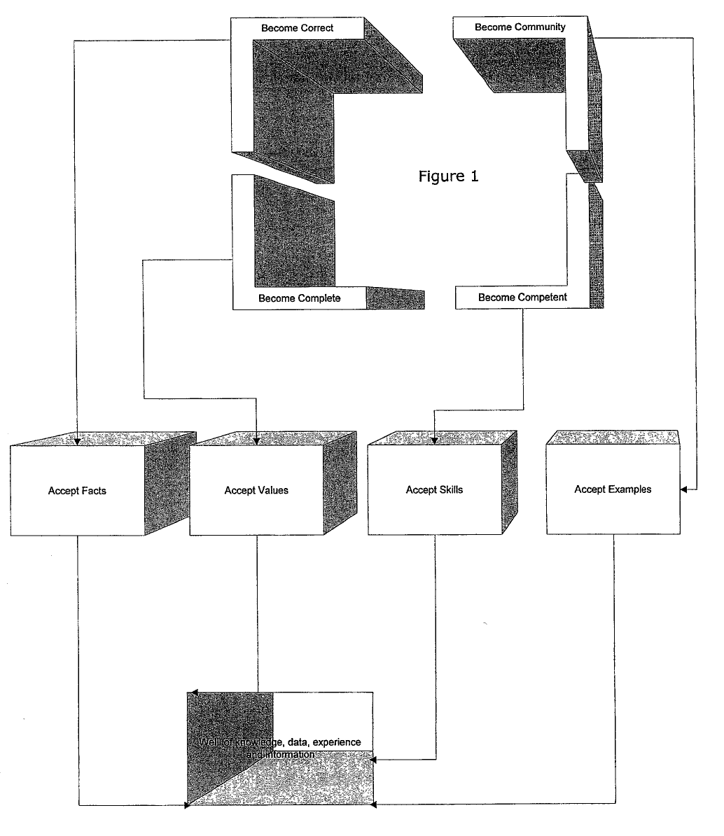

FIG. 1 illustrates the overall diagram of the gathering sequence of learning object creation both as they are sorted into the database as eMemes and then as they are delivered as Praxons. Though most instructional systems use a similar, if unstructured, approach to learning, this system provides an intentional method of gathering information into a mechanism that is understandable to others who are contributing to the same knowledge area. The invention sorts unstructured information into four learning objects or eMemes that are then gathered dynamically into a usable collection as a main point or step in an informational exchange. These four objects are directed as “topic”, “summary”, “exercise” and “example”. The four eMemes provide the learning participants to discover four outcomes that are described as an open-ended box. These components can be adapted or modified at will through the dynamic assembly process of the invention.

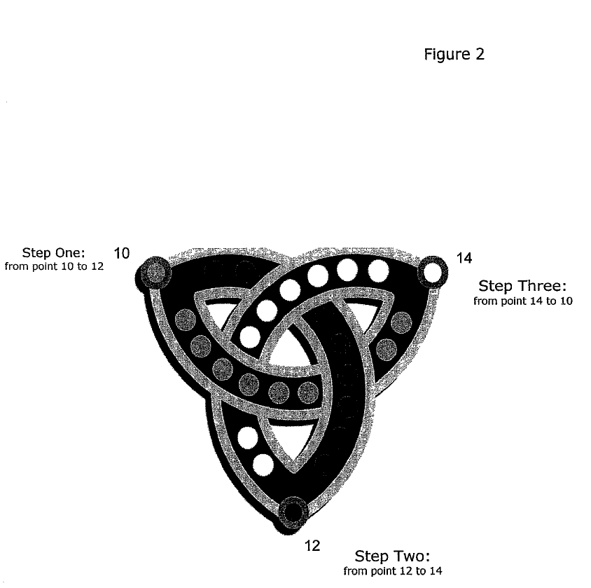

FIG. 2 shows the instructional forces that are present as the learning occurs. This invention harnesses the charges between the entities described by providing a mechanism for appropriate learning at each of three steps. This design assumes that learning is but a cognitive variant of information transfer within an organism or between components of a physical system.

The learner begins in a state of need-emanating a negative charge within the learning environment. This creates a force that either attracts or repels the individual from the community of practice. What is needed for success is a neutral charge. In this case, it is the facilitative learning support of the dyad cluster—a mentor and student. The purpose of this exchange is to be similar enough to the learner to be non-threatening; providing information that can be taken in without too much confusion or embarrassment. Once this improvement has been made, the mentor places the learner into a position where the learner can “bond” with the community of practice by integrating their need into the dynamics of the community. Once this occurs, a new connection is made, a new element is created by the addition of the learner's information and/or skill and the learner is again made aware of the need to continue development. The diagram at FIG. 2 is a slice of time.

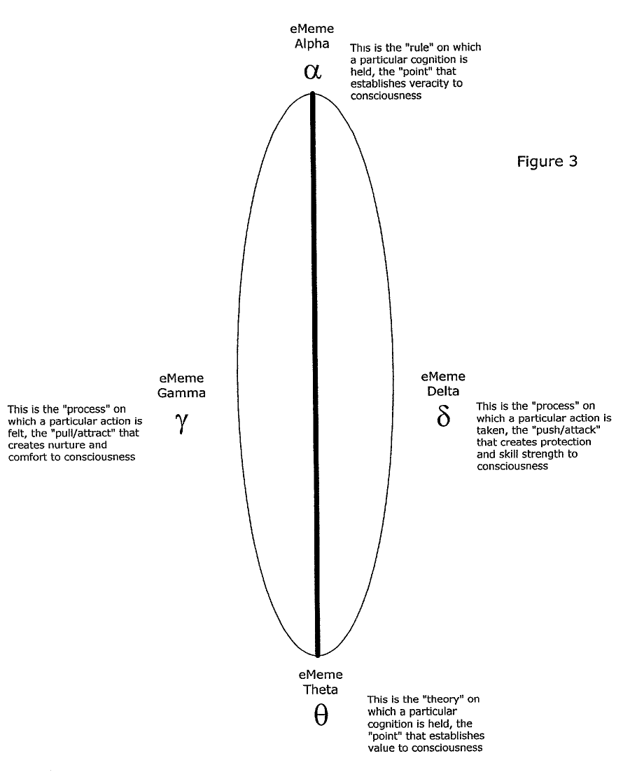

FIG. 3 outlines the forces that occur along the borderline between the three learning moments or steps of FIG. 2. This invention utilizes the four forces as learning object components of a series of clusters called Praxons. These four-way learning “molecules” are strung together across time as the need of the learner and the aptitude of the teacher dictate.

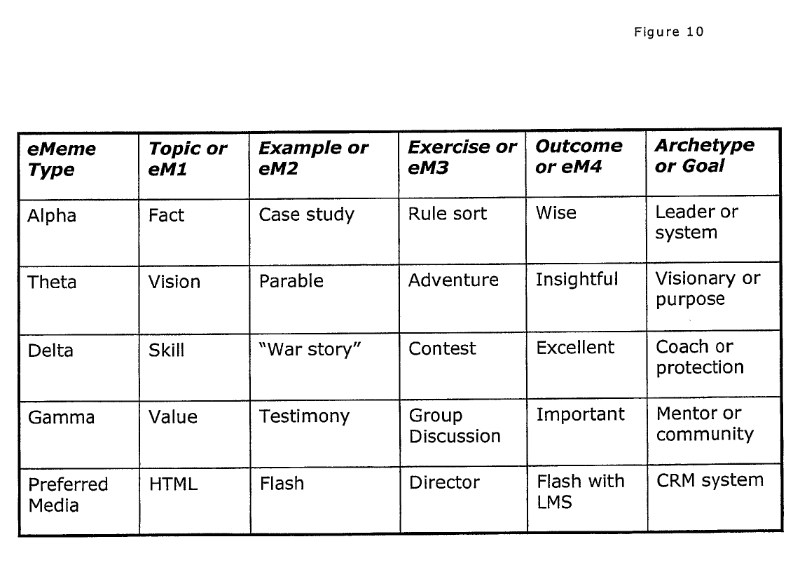

The first learning object or eMeme is noted as “alpha” since it is the usual “rule” on which a particular cognition is held, the “point” that establishes veracity to consciousness. As illustrated by FIG. 10, there are 16 different groupings into which these four eMemes can cluster. This invention provides the mechanism to begin to map the cognitive process of learning exchange. Further refinements of the invention will occur as patterns begin to emerge within the learning repositories and the tracking systems of learning management systems.

The second learning object or eMeme is its polar opposite, the point on which the string of learning is stretched. The “theta” eMeme is the “theory” on which a particular cognition is held, the “point” that establishes value to consciousness. The eMeme alpha puts a stake into the proverbial cognitive ground and the eMeme theta pulls away with the implications and purpose of that rule or fact. This invention provides a balance and counterpart system for the “rule” of training and management with the “value” of education and community.

The next two eMemes are the ones that apply the learning facts and theory. They are the “process” components that create interest, applicability and competence to otherwise uninteresting and often inert “points”. The eMeme Delta is the one most often used in training—this is the “process” on which a particular action is taken, the “push/attack” that creates protection and skill strength to consciousness. It defines competence and mastery through steps and processes of instructional activities.

The last eMeme—gamma—is the one most often relegated to the mysterious—the “soft” skill of nurture and community. It, however, is the counterpart of skill achievement. It is the “process” on which a particular action is felt, the “pull/attract” that creates nurture and comfort to consciousness. The learning component is used to mentor, to encourage, to pull into focus the needs of the whole or the team just as the eMeme delta is used to push into individuality and competitive isolation. The traditional tools used to implement this methodology are summarized briefly at FIG. 10, though they are but placeholders for a larger system of integrative learning matrices.

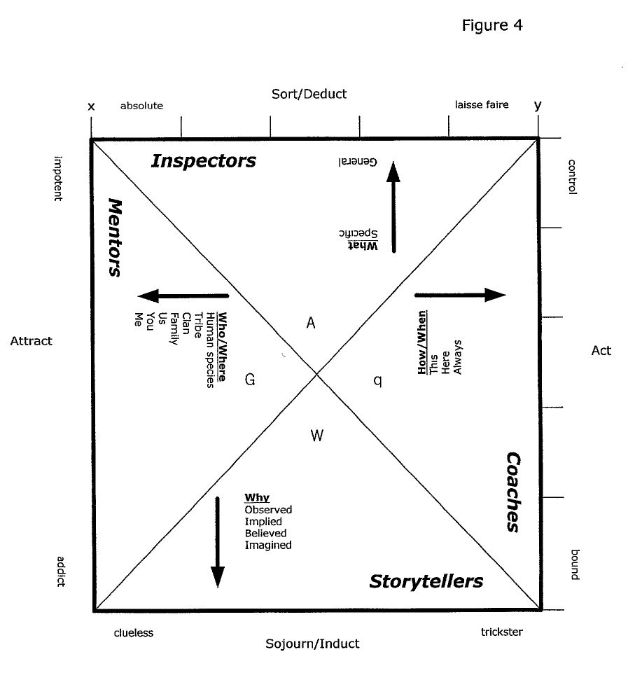

FIG. 4 charts the invention's contributions to learning development theory in light of what is traditionally done in learning content creation. The eMeme designators are at the center to indicate their contributions to the learning experience. The traditional journalism questions for investigation are next to the arrows that push learning toward the goals listed under their designators. The direction of the arrow shows the direction of information flow within the particular community of practice. The triangles are labeled with the traditional roles taken by learning practitioners who are bound to the particular role or eMeme knowledge repository. The Inspectors serve as the leader of a culture or community or practice the scale at the top of the chart show the options that can be implemented by this type of learning practitioner—from absolute ruler to laisse-faire leader. The chart illustrates each traditional learning author/practitioner in order to make clear the invention's usefulness in capturing what otherwise is often lost within the entire knowledge community due to one side labeling the other side as either too petty or too immaterial for consideration. While the purpose of this invention is to quantify the components of learning embodies the fuller clarification of the formulae that will emerge from this learning matrix. As learners begin to understand the components that make them discover meaning and expertise, this invention has the methodology to create a “learning curve” that will track the journey of eMemes preferred for learning experiences of preference and effectiveness.

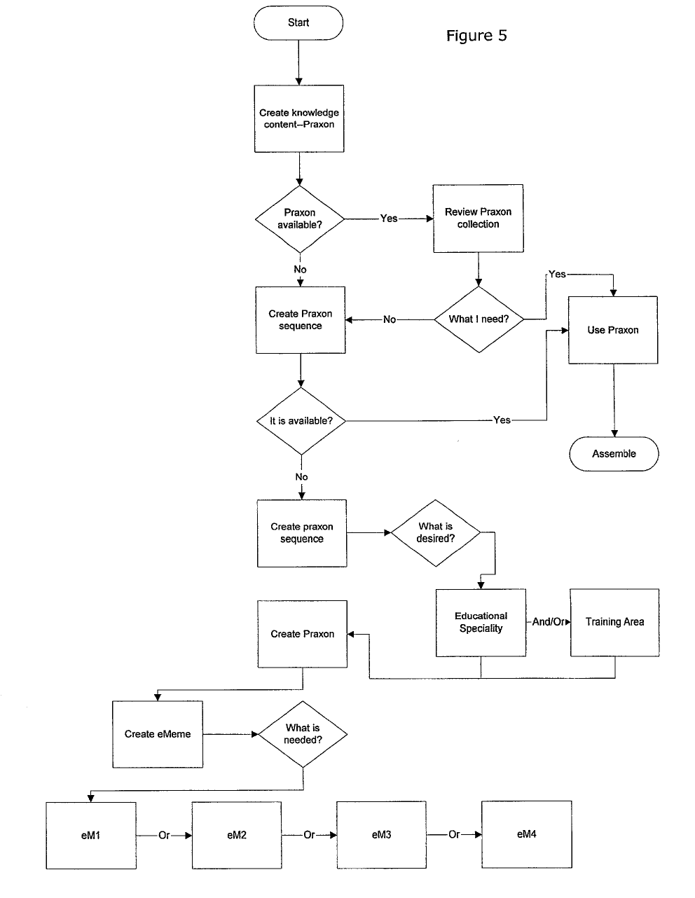

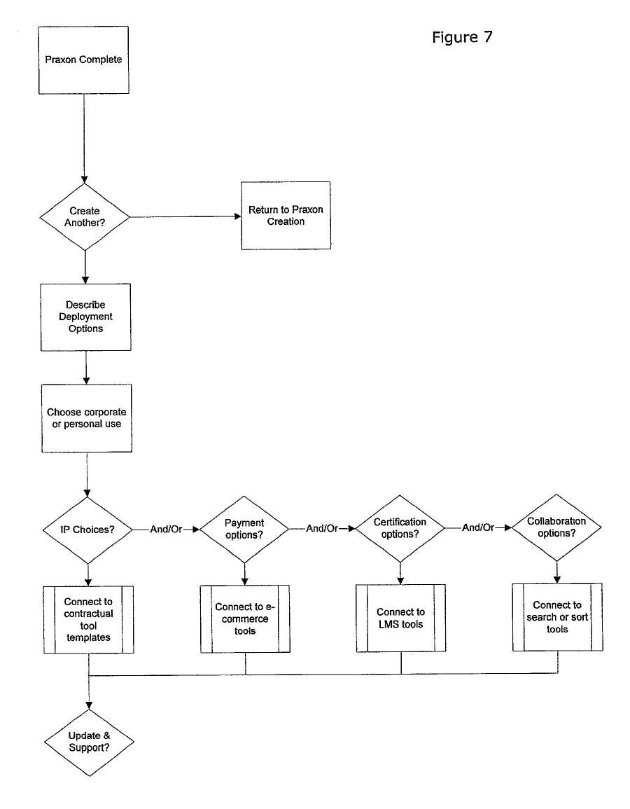

FIG. 5 describes the basic processes involved in the creation of the Praxon. While it is a high-level diagram, it embodies the intermediate steps which will be required in order to best implement the general processes described. This is first noticed in the reference to a Praxon collection. These repositories of learning objects will undoubtedly be housed in separate collections based on professional association or knowledge entity. How they are sorted, catalogued and defined will be the responsibility of the particular community of practice. But as far as the invention is concerned, it is merely a Praxon collection to be searched and sorted by traditional or conceptual searching tools. This sorting into traditional groupings is further intimated in the Praxon sequence needed for either educational accomplishment or professional competence. The means used to sort sequences is immaterial to the invention though means must be made for so noting such requirements by external collaborators and or partners. This is also implicated in FIG. 7 when commerce and competency requires other means of authentication and certification.

The key embodiment fo FIG. 5 is the series of four eMemes making up the initial Praxon. While the ideal construction technique would be to use all four, common practice indicates that the skills required to provide meaningful content for each of these is within an different community of learning practice. Each of these eMemes, as basic learning components, could be best understood from their common communication usage. From left to right they are gathering information from the following sources: eM1: The topic or item of information to be shared; eM2: the example that helps describe the topic in human terms; eM3: an exercise that puts into practice or gives opportunity to understand how the topic came into being or can be utilized; eM4: the outcome or consequence of the learning sequence often creating certification or mastery of the topic being shared. Therefore, they are able to be assembled without all components with the realization that they will be needed to complete the learning “molecule.” Initial use of the learning system will tend to a particular learning “tribe/family” that matches the roles being described or taught and designated by the invention by their Greek alphabet letter; Alpha describing systemic order for leadership; Theta describing visionary strategy for planning; Delta describing skills development for professional protection; and Gamma describing value for mentored community. Each “tribe/family” specializes in one of the four basic learning tools but approaches them for different purpose and outcomes as outlined in FIG. 10.

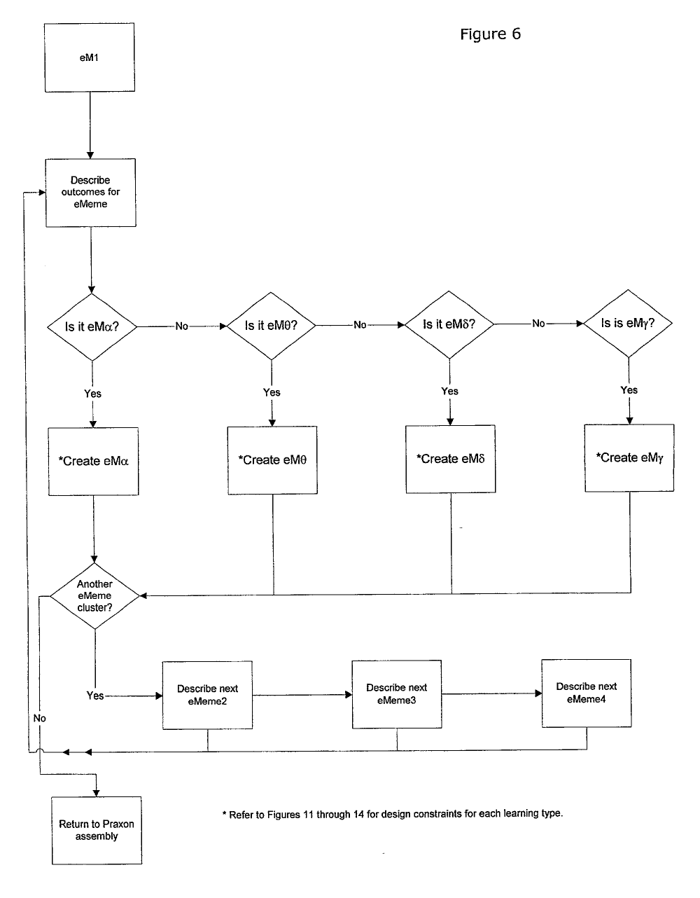

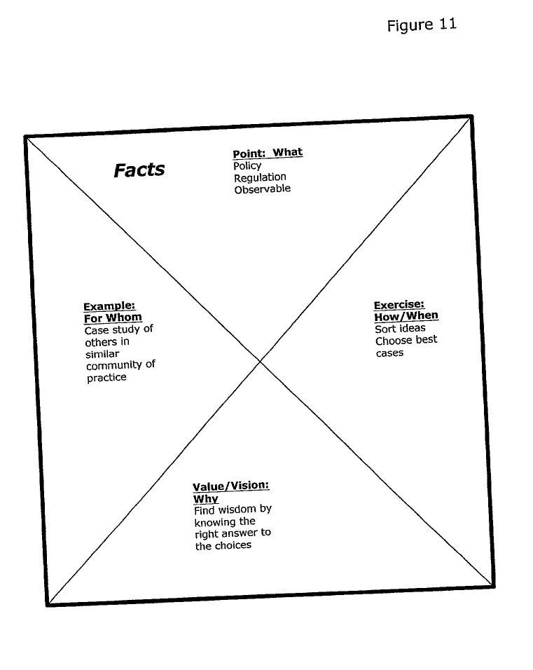

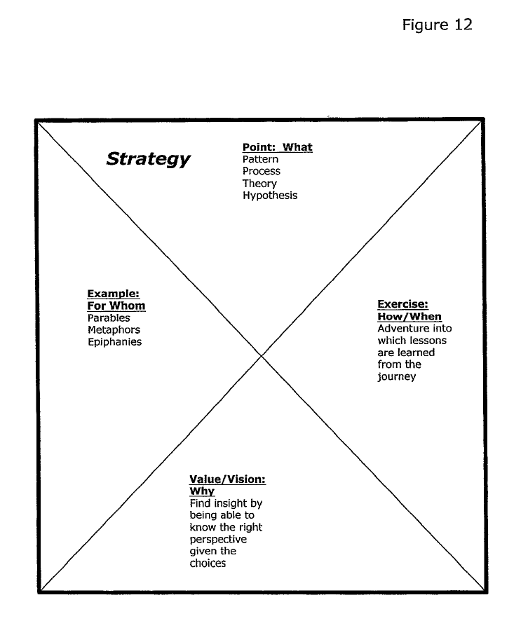

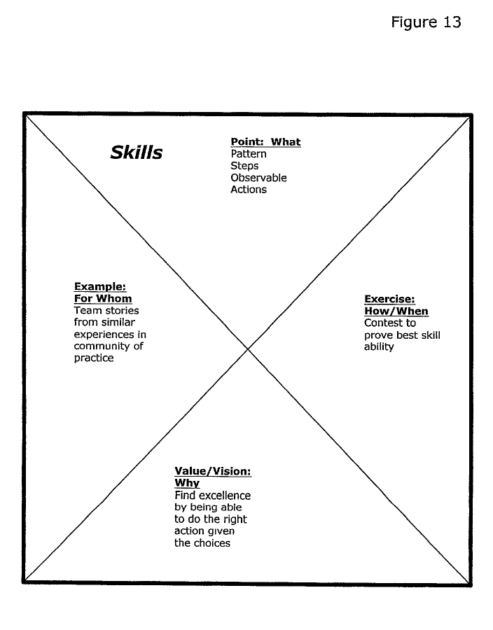

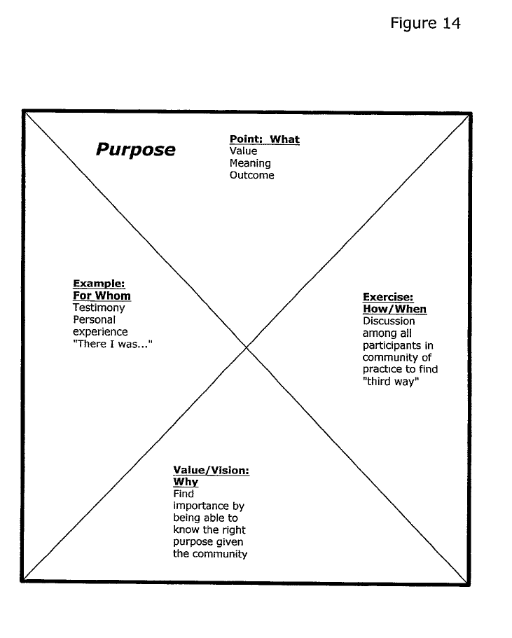

FIG. 6 shows the method for doing this full creation of a particular Praxon. After the learning object creator has been given the opportunity to contribute to the creation of a particular Praxon felt to be important to the particular community of practice from which the author comes, the choices are made for particular types of eMemes. The invention lists them as Greek superscripts to numbered eMemes. This construct provides the seemingly repetitive but crucial derivation of learning tools with learning types. While the learning tool is used for all learning types, there are preferences among these tools. Due to the inability to provide unique learning experiences for each learner in the rapidly developing learning enterprise, these tools were developed as “work-arounds” for the more classical method of individual learning from a mentor or master. Thus, in the automated, mechanized classroom of the Industrial Revolution, different learners could be taught by being instructed that they were to sit quietly while others were being helped and only ask questions of the instructor when appropriate to that teacher. But there is within the learning construct the basis of which this invention provides. The ability to be able to store the repository of each learning type is provided even though a given instructor has lost the ability or is unable—due to a personal learning preference—to provide these other types. This provides the necessary sorting construct for further automatic assembly and sorting based on user preferences and practice. While the invention seeks to begin a process of “movable thought” creation, it cannot proceed without having a “holder” for each type of the 16 variants of eMemes as outlined in greater detail at FIG. 10. An illustrative schema may prove helpful in describing the mechanism for content collection by reviewing the four “tribe/families” content needs at FIGS. 11 through 14. Each of these screens provides an interrogation with the provider or seeker of informational knowledge. Further clarification of their role and sequence can be found at their particular explanation.

FIG. 7 outlines the requirements for the invention to be practical and profitable. The invention does not presume to articulate a particular commerce, contractual, certificatory or collaborative mandate but instead insists upon a cross-platform approach to such systems. This will undoubtedly be exhibited in some specialized XML linking code sequence but does not limit the invention's reach. As an example, the Learning Management System (LMS) indicated at this figure is in development by a consortia of industry partners and will provide a simple mechanism to track performance and achievement. The invention seeks to use that system rather than to build or presume a proprietary one. The key solution provided by the invention is the ability to create a business model that treats reusable learning objects as a commodity, freely moving between creator and user through the construct of the Praxon and eMeme.

These “containers” provide a mechanism for commerce in “movable thought” just as profound a shift for the information age as Gutenburg's movable type.

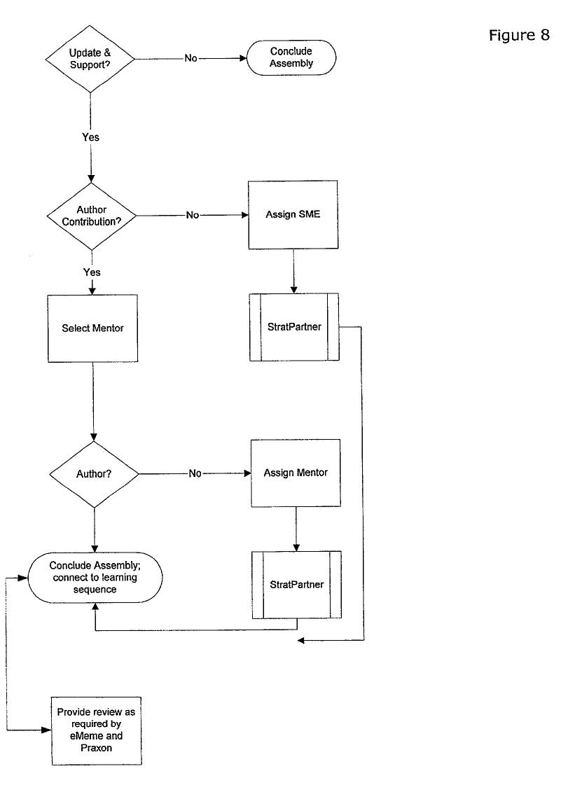

FIG. 8 shows the links that the invention intends to pursue with content providers and customer relationship management systems. The particular Praxon will be linked to the particular learning management system that is responsible for updating the content, revising its applicability and/or mentoring the users of that particular Praxon collection. The particular choice of mentor/coach will primarily depend on the level of interaction chosen by the user. The level chosen through tools outlined in FIG. 7 will provide permission and accountability to the learner so that improved skills, knowledge, value and community are among the mix of outcomes available to the person using the system or expecting such outcomes as its provider. The purpose of the mentor/coach is similar to that of the subject matter expert/author in that the only contribution to the system is when the current content Praxons and eMemes are inadequate to the task at hand. The current invention provides process for this endeavor; subsequent revisions will undoubtedly make more clear what further clarification and refinements to the system will be required once an adequate number of users begin to invoke the system.

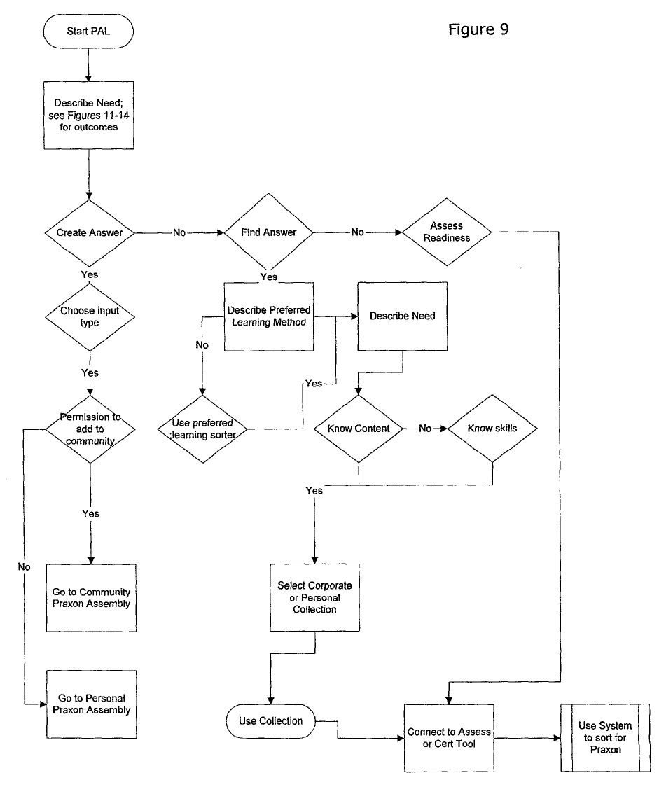

FIG. 9 illustrates, at a high-level design outline, the particulars of the personal assistant for learning or PAL. This subset of the invention is designed for users of the content who either desire to purchase collections of Praxons for professional expertise or experience or who wish to contribute to the community of practice as a recognized user. This system will be customized to insert itself into the corporate Web presence and/or media distribution system being used such as wireless phone or personal digital assistants such as Palm Pilots. The purpose of the process diagram of FIG. 9 is to outline the process flow of information between user and content creator. The design is expected to one that either works within the corporate design or comes as a “pop-up” window available at anytime to the user. The purpose of the personal assistant for learning or PAL is to create a connection between the user and the content. The connection is made more robust by the fact that there is a mechanism whereby the user can either contribute to or benefit the overall community of practice from which content has been retrieved. Understandably, some of the content created by the user may not be useful to the overall community at its first use but may later be found useful. The ability to have a personal repository of learning objects as well as those of the larger community of practice provides a mechanism for reusable thought that can either be shared or purchased from the content creator. The addition of a learning assessment to the learning method description does not presume to create a particular learning assessment system but rather to integrate those already available into the learning paradigm being described.

FIG. 10 describes the elements used in traditional learning experiences to create instructional value. They have been sorted into the invention's terminology for clarify in implementing the invention from within unstructured content. The further embodiment of this invention would be to create an automatic tagging system for gathering content of these types into eMemes for later assembly into meaningful Praxons.

As illustrated with respect to FIGS. 11-14, the design metaphor for an input screen provides useful documentation for the types of information that will be gathered by both content creators and content users. The design provides a symbolic representation for what will be adapted to human interface design constraints. The four quadrants are provided as an intuitive representation that could also follow a standard color scheme to match the particular “family” of learning type, i.e. red for skill, green for purpose, yellow for vision and blue for rule. The four quadrants also indicate the intuitive purpose for the individual learning “tribe/family” as they are overlaid on the particular tool of that learning sequence. Each quadrant has the same purpose—to provide tools for topic, example, exercise and summary—but the type of information needed by the learning family will be different as illustrated by the four figures. The interface will connect to the Praxon creation process outlined at FIG. 5 as well as the outcomes of the PAL at FIG. 9. It will also provide a useful mechanism for the knowledge management type of information that is unformed and incomplete at its recognition but could become part of a larger learning sequence for a particular learning family once it has been integrated through such an information gathering conduit.

What is claimed is:

1. A method for creating learning content in the form of a learning cluster to be used between a teacher and a student, comprising the steps of:
sorting the learning cluster into a structured collection of four learning objects, a first of said learning objects directed to a rule taught by the learning cluster, a second of said learning objects directed to the theory of said rule of said first of said learning objects, a third of said learning objects illustrating said rule and said theory and the fourth of said learning objects directed to value judgement;
creating a data base of each of said four learning objects for a particular learning cluster;
entering said data base in an electronic storage media; and
accessing said data base in a manner allowing interplay between the teacher and the student to facilitate the mastery of the learning cluster by the student.

2. The method in accordance with claim 1, further including the steps of
monitoring the interplay between the teacher and the student;
noting a pattern created by the interplay between the teacher and the student; and
providing additional interplay between the teacher and the student based upon said pattern.

3. A system for facilitating a teacher to teach a concept to a student, comprising:
an electronic data base including a plurality of concepts to be learned by the student, each of said concepts classified in said data base as a structural collection of four learning objects, a first of said learning objects directed to a rule taught by said concept, a second of said learning objects directed to the theory of said rule of said first of said learning objects, a third of said learning objects illustrating said rule and said theory and the fourth of said learning objects directed to a value judgement;
input device for accessing said electronic data base; and
display device for displaying information provided in said electronic data basis.

4. The system in accordance with claim 3, wherein said electronic data base is connected to the Internet.

5. The system in accordance with claim 3 further including a means in communication with said electronic data base for monitoring an interplay between the teacher and the student for sensing a pattern created by said interplay and providing additional interplay between the teacher and the student based upon said pattern.

6. The system in accordance with claim 4 further including a means in communication with said electronic data base for monitoring an interplay between the teacher and the student for sensing a pattern created by said interplay and providing additional interplay between the teacher and the student based upon said pattern.
